(19) United States
(12) Patent Application Publication
(10) Pub. No.: US 2023/0105685 A1
(43) Pub. Date: Apr. 6, 2023

(54) POLYURETHANE COMPOSITIONS, PRODUCTS PREPARED WITH SAME AND PREPARATION METHODS THEREOF

(71) Applicant: Dow Global Technologies LLC, Midland, MI (US)

(72) Inventors: Yanbin Fan, Shanghai (CN); Dewen Nie, Shanghai (CN); Ping Zhang, Shanghai (CN); Shaoguang Feng, Shanghai (CN)

(73) Assignee: Dow Global Technologies LLC, Midland, MI (US)

(21) Appl. No.: 17/909,890

(22) PCT Filed: Mar. 30, 2020
(86) PCT No.: PCT/CN2020/081994

§ 371 Date: Sep. 7, 2022

(51) Int. Cl. C08G 18/32; C08G 18/10; C08K 5/526

(52) U.S. Cl. CPC C08G 18/3278; C08G 18/3206; C08G 18/10; C08K 5/526

(57) ABSTRACT

A polyurethane composition is provided. The polyurethane composition comprises one polyisocyanate component comprising at least one aromatic polyisocyanate compound and/or isocyanate end-capped prepolymer formed by the reaction of said at least one aromatic polyisocyanate compound and at least one first polyol; at least one second polyol; and a crosslinker having at least one nitrogen atom and at least one secondary and/or tertiary hydroxyl group. The polyurethane product prepared by using the polyurethane composition can achieve improved operation time, aging resistance, weathering resistance, color stability, processability, and storage stability. A method for preparing the polyurethane product and a method for improving the performance property of the polyurethane product are also provided.

### FIELD OF THE INVENTION

The present disclosure relates to a polyurethane composition, a polyurethane product prepared by using the composition, a method for preparing the polyurethane product and a method for improving the performance properties of the polyurethane product. The polyurethane composition exhibits improved flowability and prolonged operation time, and the polyurethane product exhibits excellent properties such as enhanced aging resistance, weathering resistance, color stability, storage stability and better processability.

### BACKGROUND TECHNOLOGY

Polyurethane materials can be foamed into various shapes and are usually fabricated via a two-component process comprising the steps of reacting a first component mainly comprising polyols and optional additives such as catalysts, surfactants, foaming agents, etc. with a second component which comprises one or more isocyanate end-capped prepolymers obtained by reacting polyols with polyisocyanates. The two components are blended at high speed and then transferred into varied molds with desired shapes. Over the past decades, foamed polyurethane materials have been employed in a wide range of end use applications like shoemaking (e.g., soles) and automotive industries (e.g., bumpers and arm rests of integral skin foams). One important application of the polyurethane materials is window-encapsulation, wherein a gasket is molded around the periphery of a glass window, in particular a car window, wherein the gasket serves to mount the window in the car frame. This molded polyurethane gasket material must meet very severe requirements such as fast demoldability and good light stability. To this aspect, aliphatic or alicyclic isocyanates are usually preferred options as they provide better light stability in comparison with aromatic isocyanates. However, aliphatic or alicyclic isocyanates are usually more expensive, show low reactivity and thus long demolding cycles, and the resultant polyurethanes show inferior physical strengths. Great efforts have been made to develop unique polyurethane systems which can retain the above said advantages while avoiding said shortcomings, by e.g. modifying the molecular structure of the isocyanate or isocyanate-reactive compound raw materials and including specific processing additives, but none of these previous researches successfully achieve the technical object, and some new problems such as increased volatile organic compounds (VOC) and unpleasing odor also arise, which are especially not favored in automotive industry since the encapsulated windows are partial interiors of cars.

For the above reasons, there is still a need in the polyurethane manufacture industry to develop a polyurethane composition whose performance properties as stated above can be improved with an economical way. After persistent exploration, the inventors have surprisingly developed a polyurethane composition which can achieve all of the above targets.

### SUMMARY OF THE INVENTION

The present disclosure provides a unique polyurethane composition, a molded polyurethane product prepared by using the composition, a method for preparing the polyurethane product and a method for improving the performance properties of the polyurethane product.

In a first aspect of the present disclosure, the present disclosure provides a polyurethane composition, comprising one polyisocyanate component comprising at least one aromatic polyisocyanate and/or isocyanate end-capped prepolymer derived from the reaction of said at least one aromatic polyisocyanate compound and at least one first polyol; at least one second polyol; and a crosslinker having at least one nitrogen atom and at least one secondary and/or tertiary hydroxyl group. In a preferable embodiment of the present disclosure, the polyurethane composition is a two-component composition comprising: (A) a component A comprising the aromatic polyisocyanate compounds and/or the isocyanate end-capped prepolymers; and (B) a component B comprising two second polyols and the crosslinker. According to another preferable embodiment of the present disclosure, the crosslinker is represented by Formula (I):

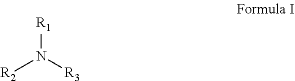

wherein each of R₁, R₂ and R₃ is independently selected from the group consisting of hydrogen, C₁ to C₁₀ alkyl, C₃ to C₁₀ cycloalkyl, methyl(hydroxyl)C₁ to C₉ alkylene, ethyl(hydroxyl)C₁ to C₈ alkylene, propyl(hydroxyl) C₁ to C₇ alkylene, butyl(hydroxyl) C₁ to C₆ alkylene, dimethyl(hydroxyl)C₁ to C₈ alkylene, diethyl(hydroxyl)C₁ to C₆ alkylene, dipropyl(hydroxyl) C₁ to C₄ alkylene, di(C₁ to C₁₀ alkyl group)amino, di(C₁ to C₁₀ alkyl group)amino-C₁ to C₁₀ alkylene, di[methyl(hydroxyl)C₁ to C₈ alkylene]amino and di[methyl(hydroxyl)C₁ to C₈ alkylene]amino-C₁ to C₁₀ alkylene, with the proviso that the crosslinker comprises at least one secondary and/or tertiary hydroxyl group. The crosslinker preferably comprises from three to six secondary and/or tertiary hydroxyl groups. More preferably, the crosslinker is selected from the group consisting of tri(2-hydroxyl-ethyl)amine, triisopropanolamine, triisobutanolamine, triisopentanolamine, tetra(2-hydroxyl-ethyl)diamine, tetra(isobutanol)diamine, tetra(isopentanol)diamine, tri(tert-butanol)amine, tri(tert-pentanol)amine, tri(tert-hexanol)amine, N,N,N″,N″-tetra(2-hydroxypropyl) diethylenetriamine, N,N,N′,N″,N″-pentakis(2-hydroxypropyl) diethylene-triamine and any combinations thereof. In a preferable embodiment of the present disclosure, the amount of the crosslinker is from 0.1 to 10% by weight, based on the total weight of the component B. According to another preferable embodiment of the present disclosure, the component A further comprises a peroxide decomposer. The peroxide decomposer is preferably selected from the group consisting of aliphatic organophosphite, aromatic organophosphite, aliphatic sulfur ether, aromatic sulfur ether, and any combinations thereof; and the amount of the peroxide decomposer is from 0.1 to 17.5% by weight, based on the total weight of the component A. According to another preferable embodiment of the present disclosure, the aromatic polyisocyanate compound comprises at least one aryl group and all the isocyanate groups are directly attached to the aryl groups without the existence of any interlink group therebetween. According to another preferable embodiment of the present disclosure, the component B further comprises at least one additive selected from the group consisting of chain extender, catalyst, antioxidant, UV absorber, light stabilizer, colorant, dye, pigment, anti-statistic reagent, plasticizer, flame-retardant agent, and any combinations thereof. According to another preferable embodiment of the present disclosure, the polyisocyanate compound is selected from the group consisting of C₆-C₁₅ aromatic polyisocyanate comprising at least two isocyanate groups, C₇-C₁₅ araliphatic polyisocyanate comprising at least two isocyanate groups, carbodiimide modified derivatives thereof, and any combinations thereof; and each of the first polyols and the second polyols are independently selected from the group consisting of C₂-C₁₆ aliphatic polyhydric alcohols comprising at least two hydroxy groups, dimer of the C₂-C₁₆ aliphatic polyhydric alcohols comprising at least two hydroxy groups, trimer of the C₂-C₁₆ aliphatic polyhydric alcohols comprising at least two hydroxy groups, C₆-C₁₅ cycloaliphatic or aromatic polyhydric alcohols comprising at least two hydroxy groups, C₇-C₁₅ araliphatic polyhydric alcohols comprising at least two hydroxy groups, polyester polyols having a molecular weight from 500 to 5,000, polycarbonate polyols having a molecular weight from 200 to 5,000, polyether polyols having an average functionality of 2 to 5 and an average molecular weight of 200 to 12,000, C₂ to C₁₀ polyamine comprising at least two amino groups, C₂ to C₁₀ polythiol comprising at least two thiol groups, C₂-C₁₀ alkanolamine comprising at least one hydroxyl group and at least one amino group, vegetable oil having at least two hydroxyl groups, and a combination thereof.

In a second aspect of the present disclosure, the present disclosure provides a polyurethane product prepared by using the polyurethane composition according to the present disclosure.

In a third aspect of the present disclosure, the present disclosure provides a method for preparing the polyurethane product according to the present disclosure, wherein the method comprises the steps of i) providing the isocyanate component; and ii) reacting the isocyanate component with the second polyols and the crosslinkers to form the polyurethane product.

In a fourth aspect of the present disclosure, the present disclosure provides a method for improving the performance property of the polyurethane product, comprising the step of covalently linking at least one repeating unit derived from a crosslinker having at least one nitrogen atom and at least one secondary and/or tertiary hydroxyl group in a polyurethane chain of the polyurethane product, wherein the performance property includes at least one of operation time, flowability, aging resistance, weathering resistance, color stability, processability, and storage stability.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. Unless indicated otherwise, all the percentages and ratios are calculated based on weight, and all the molecular weights are number average molecular weights.

According to an embodiment of the present disclosure, the polyurethane composition is a “two-component”, “two-part” or “two-package” composition comprising at least one polyisocyanate component (A) and a polyol component or an isocyanate-reactive component (B), wherein the polyisocyanate component (A) with free isocyanate groups comprises aromatic polyisocyanate compound and/or an isocyanate end-capped prepolymer prepared by reacting said aromatic polyisocyanate compound with a first polyol, and the polyol/isocyanate-reactive component (B) comprises at least one second polyol, a special crosslinker having at least one nitrogen atom and at least one secondary and/or tertiary hydroxyl group(s), and some optional additives. According to a preferable embodiment of the present disclosure, a peroxide decomposer is also added into the polyisocyanate component (A) to achieve a further enhancement in light stability of the polyurethane product, which will be particularly discussed hereinafter. In the context of the present disclosure, the terms “polyisocyanate component (A)” and “component A” are used interchangeably, and the terms “polyol component (B)”, “isocyanate-reactive component (B)” and “component B” are used interchangeably. The polyisocyanate component (A) and the polyol/isocyanate-reactive component (B) are transported and stored separately, combined shortly or immediately before being applied during the manufacture of the polyurethane product, such as gasket for motor window. Once combined, the isocyanate groups in component (A) reacts with the isocyanate-reactive groups (particularly, hydroxyl group) in component (B) to form polyurethane. Without being limited to any specific theory, it is believed that special crosslinkers with amino and secondary and/or tertiary hydroxyl group(s) can unexpectedly improve the performance properties of the polyurethane product.

In various embodiments, component A may comprise (a) aromatic polyisocyanate compound; (b) isocyanate end-capped prepolymer derived from the reaction between said aromatic polyisocyanate compound and the first polyol; and (c) a mixture of (a) and (b). According to a preferable embodiment of the present disclosure, component A comprises a mixture of (a) and (b). According to various embodiments of the present disclosure, the polyisocyanate compound used for the component A is an aromatic compound having at least two isocyanate groups. According to a preferable embodiment of the present disclosure, the polyisocyanate compound comprises at least one aromatic ring (e.g. aryl group or heteroaryl group) and all the isocyanate groups in the polyisocyanate compound are directly attached to the aromatic rings without the existence of any interlink group therebetween. In a preferable embodiment, the aromatic polyisocyanate compound can be selected from the group consisting of C₆-C₁₅ aromatic polyisocyanates comprising at least two isocyanate groups, dimer of the C₆-C₁₅ aromatic polyisocyanates comprising at least two isocyanate groups, trimer of the C₆-C₁₅ aromatic polyisocyanates comprising at least two isocyanate groups, C₇-C₁₅ araliphatic polyisocyanates comprising at least two isocyanate groups, dimer of the C₇-C₁₅ araliphatic polyisocyanates comprising at least two isocyanate groups, trimer of the C₇-C₁₅ araliphatic polyisocyanates comprising at least two isocyanate groups, and combinations thereof. Carbodiimide modified derivatives of the above stated aromatic polyisocyanates may also be used for preparing the component A, wherein the term carbodiimide modified derivatives may comprise carbodiimide modified C₆-C₁₅ aromatic polyisocyanates comprising at least two isocyanate groups, carbodiimide modified dimer of the C₆-C₁₅ aromatic polyisocyanates comprising at least two isocyanate groups, carbodiimide modified trimer of the C₆-C₁₅ aromatic polyisocyanates comprising at least two isocyanate groups, carbodiimide modified C₇-C₁₅ araliphatic polyisocyanates comprising at least two isocyanate groups, carbodiimide modified dimer of the C₇-C₁₅ araliphatic polyisocyanates comprising at least two isocyanate groups, carbodiimide modified trimer of the C₇-C₁₅ araliphatic polyisocyanates comprising at least two isocyanate groups, and combinations thereof. In another preferable embodiment, suitable aromatic polyisocyanate compounds include m-phenylene diisocyanate, 2,4-toluene diisocyanate and/or 2,6-toluene diisocyanate (TDI), the various isomers of diphenylmethanediisocyanate (MDI), carbodiimide modified MDI products, naphthylene-1,5-diisocyanate, or mixtures thereof. Generally, the amount of the aromatic polyisocyanate compound may vary based on the actual requirement of the polyurethane product and the window gasket. For example, as one illustrative embodiment, the content of the aromatic polyisocyanate compound can be from 15 wt % to 60 wt %, or from 20 wt % to 50 wt %, or from 23 wt % to 40 wt %, or from 25 wt % to 35 wt %, based on the total weight of the polyurethane composition. According to a preferable embodiment of the present disclosure, the amount of the polyisocyanate compound is properly selected so that the isocyanate group is present at a stoichiometric molar amount relative to the total molar amount of the hydroxyl groups included in the first polyol, the second polyol, the crosslinker and any additional additives or modifiers. According to a preferable embodiment of the present disclosure, the polyisocyanate component (A) prepared by reacting the aromatic polyisocyanate compound with the at least one first polyol has a NCO group content of from 2 to 50 wt %, preferably from 6 to 49 wt %, such as from 10 to 40 wt %, from 12 to 32 wt %, and may also have a NCO content in the numerical range obtained by combining any two of the above stated end point values. According to another preferable embodiment of the present disclosure, the polyisocyanate component (A) prepared by reacting the aromatic polyisocyanate compound with the at least one first polyol has a viscosity below 1500 mPa·s at room temperature.

According to various embodiments of the present disclosure, each of the first polyol and the second polyol can be independently selected from the group consisting of C₂-C₁₆ aliphatic polyhydric alcohols comprising at least two hydroxy groups, dimer of the C₂-C₁₆ aliphatic polyhydric alcohols comprising at least two hydroxy groups, trimer of the C₂-C₁₆ aliphatic polyhydric alcohols comprising at least two hydroxy groups, C₆-C₁₅ cycloaliphatic or aromatic polyhydric alcohols comprising at least two hydroxy groups, C₇-C₁₅ araliphatic polyhydric alcohols comprising at least two hydroxy groups, polyester polyols having a molecular weight from 500 to 5,000, polycarbonate polyols having a molecular weight from 200 to 5,000, polyether polyols having an average functionality of 2 to 5 and an average molecular weight of 200 to 12,000, C₂ to C₁₀ polyamine comprising at least two amino groups, C₂ to C₁₀ polythiol comprising at least two thiol groups, C₂-C₁₀ alkanolamine comprising at least one hydroxyl group and at least one amino group, vegetable oil having at least two hydroxyl groups, and a combination thereof. In one preferable embodiment of the present application, the first polyol is a monomer polyol selected from the group consisting of ethylene diol, propylene diol, butylene diol, diethylenediol, triethylene diol, dipropylene diol, tripropylene diol, and any combination thereof. In another preferable embodiment of the present application, the second polyol comprises at least one polyether polyol having an average functionality of 2 to 5 and an average molecular weight of 200 to 12,000. In another preferable embodiment of the present application, the content of the second polyol is at least 60 wt %, based on the weight of component B. In another preferable embodiment of the present application, the polyether polyol is a copolymer derived from polyethylene oxide and polypropylene oxide, wherein the amount of polymerization unit derived from the polyethylene oxide is less than 20 wt %, preferably less than 15 wt %, based on the total weight of the polyether polyol. In another preferable embodiment of the present application, at least 70%, preferably at least 80% hydroxyl groups in the polyether polyol are primary OH groups. With being limited to any specific theory, the above stated properties of the polyether polyol are beneficial for achieving efficient curing and demolding.

According to various embodiment of the present disclosure, the polyether polyols is generally prepared by polymerization of one or more alkylene oxides selected from propylene oxide (PO), ethylene oxide (EO), butylene oxide, tetrahydrofuran and mixtures thereof, with proper starter molecules in the presence of catalyst. Typical starter molecules include compounds having at least 2, preferably from 4 to 8 hydroxyl groups or having two or more primary amine groups in the molecule. Suitable starter molecules are for example selected from the group comprising aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. By way of starter molecules having at least 2 and preferably from 2 to 8 hydroxyl groups in the molecule it is preferable to use trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Catalyst for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In a preferable embodiment of the present disclosure, the polyether polyol includes (methoxy) polyethylene glycol (MPEG), polyethylene glycol (PEG), poly(propylene glycol) or copolymer of ethylene epoxide and propylene epoxide with primary hydroxyl ended group and secondary hydroxyl ended group.

According to various embodiments of the present disclosure, one of the technical breakthrough of the present disclosure resides in the inclusion of a special crosslinker, which comprises at least one nitrogen atom and at least one secondary and/or tertiary hydroxyl group, in the polyurethane composition. The crosslinker can be either provided as a component independent from component A and B, or as part of the component B. According to a preferable embodiment of the present application, the crosslinker is included in the component B and is not included in the component A. According to another embodiment of the present disclosure, the crosslinker has a molecular structure represented by Formula (I):

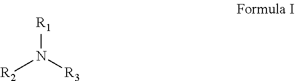

wherein each of R₁, R₂ and R₃ is independently selected from the group consisting of hydrogen, C₁ to C₁₀ alkyl, C₃ to C₁₀ cycloalkyl, methyl(hydroxyl)C₁ to C₉ alkylene, ethyl(hydroxyl)C₁ to C₈ alkylene, propyl(hydroxyl) C₁ to C₇ alkylene, butyl(hydroxyl) C₁ to C₆ alkylene, dimethyl(hydroxyl)C₁ to C₈ alkylene, diethyl(hydroxyl)C₁ to C₆ alkylene, dipropyl(hydroxyl) C₁ to C₄ alkylene, di(C₁ to C₁₀ alkyl group)amino, di(C₁ to C₁₀ alkyl group)amino-C₁ to C₁₀ alkylene, di[methyl(hydroxyl)C₁ to C₈ alkylene]amino and di[methyl(hydroxyl)C₁ to C₈ alkylene]amino-C₁ to C₁₀ alkylene, with the proviso that the first crosslinker comprise at least one secondary group and/or tertiary hydroxyl group. According to another preferable embodiment of the present disclosure, the crosslinker comprises from three to six secondary and/or tertiary hydroxyl groups. According to another preferable embodiment of the present disclosure, the crosslinker is selected from the group consisting of tri(2-hydroxyl-ethyl)amine, triisopropanolamine, triisobutanolamine, triisopentanolamine, tetra(2-hydroxyl-ethyl)diamine, tetra(isobutanol)diamine, tetra(isopentanol)diamine, tri(tert-butanol)amine, tri(tert-pentanol)amine, tri(tert-hexanol)amine, N,N,N″,N″-tetra(2-hydroxypropyl) diethylenetriamine, N,N,N′,N″,N″-pentakis(2-hydroxypropyl) diethylenetriamine and any combinations thereof.

According to another preferable embodiment of the present disclosure, the amount of the crosslinker is from 0.1 to 10% by weight, preferably from 1.0 to 6.0% by weight, based on the total weight of the component B.

According to various embodiments of the present disclosure, another technical breakthrough of the present disclosure resides in the inclusion of a peroxide decomposer in component A. In the context of the present disclosure, the “peroxide decomposer” refers to a reagent which can decompose a peroxide (i.e. a compound having a peroxide bridging group “—O—O—”) into a product that is free of free-radical, inert to reaction and thermally stable. According to a preferable embodiment of the present application, the peroxide decomposer is hydrolysis-prone. Examples of the peroxide decomposer include P(III)-containing organic compounds such as aliphatic organophosphite, aromatic organophosphite; and sulfur-containing organic compounds such as aliphatic sulfur ether, aromatic sulfur ether, and any combinations thereof. According to a preferable embodiment of the present disclosure, the peroxide decomposer is an aromatic organophosphite comprising more than one phosphite groups and at least two phenyl rings. More preferable, the peroxide decomposer is tetraphenyl dipropyleneglycol diphosphite. According to a preferable embodiment of the present disclosure, the amount of the peroxide decomposer is from 0.1 to 17.5% by weight, such as from 0.5 to 15% by weight, or from 1 to 12% by weight, or from 1.5 to 10% by weight, or from 2 to 8% by weight, or from 2.5 to 6% by weight, or from 3 to 5% by weight, based on the total weight of the component A. The amount of the peroxide decomposer can also be within in the numerical range obtained by combining any two of the above stated end point values. According to a preferable embodiment of the present disclosure, the peroxide decomposer is included in component A, and is not added in component B. Without being limited to any special theory, it is estimated that the peroxide decomposers may bring about certain synergistic effect, e.g. in combination with other ingredients in the polyurethane composition, and can effectively achieve improved weathering resistance and inhibited negative effect of the residual catalysts in the final polyurethane product.

In various embodiments of the present disclosure, the polyurethane composition may further comprise one or more additives selected from the group consisting of catalyst, chain extender, antioxidant, UV absorber, light stabilizer, colorant, dye, pigment, and any combinations thereof. Besides, the polyurethane composition may also further comprise one or more additional additives selected from the group consisting of anti-statistic reagent, plasticizer, flame-retardant agent, crosslinkers other than those particularly defined above, blowing agents, foam stabilizers, tackifiers, rheology modifiers, fillers, water scavengers, surfactants, solvents, diluents, slippery-resistance agents, preservatives, biocides, and combinations of two or more thereof. These additives can be transmitted and stored as independent components and incorporated into the polyurethane composition shortly or immediately before the combination of components (A) and (B). Alternatively, these additives may be contained in either of components (A) and (B) when they are chemically inert to the isocyanate group or the isocyanate-reactive group. According to a preferable embodiment of the present disclosure, the above stated chain extender, antioxidant, UV absorber, light stabilizer, colorant, dye and pigment are contained in component B.

The reaction between the aromatic polyisocyanate compound and the first polyol, and the reaction between the polyisocyanate component (A) and the second polyols may occur in the presence of one or more catalysts that can promote the reaction between the isocyanate group and the hydroxyl group. Without being limited to theory, the catalysts can include, for example, glycine salts; tertiary amines; tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt; titanium (IV) based catalysts such as such as tetraisopropyl titanate, tetra(n-butyl) titanate, tetraoctyl titanate, titanium acetic acid salts, titanium diisopropoxybis(acetylacetonate), and titanium diisopropoxybis (ethyl acetoacetate); zirconium-based catalysts such as zirconium tetraacetylacetonate, zirconium hexafluoroacetylacetonate, zirconium trifluoroacetylacetonate, tetrakis (ethyltrifluoroacetyl-acetonate) zirconium, tetrakis(2,2,6,6-tetramethyl-heptanedionate), zirconium dibutoxybis (ethylacetoacetate), and zirconium diisopropoxybis (2,2,6,6-tetramethyl-heptanedionate); or mixtures thereof. According to a most preferable embodiment of the present disclosure, the catalyst for the reaction between component A and component B is a bismuth salts of organic carboxylic acids, e.g., bismuth (III) octanoate or bismuth (III) neodecanoate.

According to a preferable embodiment of the present application, the catalyst for the reaction between component A and B is an organometallic catalyst stated above.

In general, the content of the catalyst used herein is larger than zero and is at most 3.0 wt %, preferably at most 2.5 wt %, more preferably at most 2.0 wt %, based on the total weight of the polyurethane composition.

A chain extender may be present in the reactants that form the polyurethane material. In the context of the present disclosure, the chain extender is different from the special crosslinker as stated above, i.e. the chain extender is not a compound having at least one nitrogen atom and at least one secondary and/or tertiary hydroxyl group. According to an embodiment of the present disclosure, the chain extender is a chemical having two isocyanate-reactive groups per molecule and an equivalent weight per isocyanate-reactive group of less than 300, preferably less than 200 and especially from 31 to 125. The isocyanate reactive groups are preferably hydroxyl, primary aliphatic or aromatic amino or secondary aliphatic or aromatic amino groups. Representative chain extenders include ethylene glycol, diethylene glycol, triethylene glycol, 1,2-propylene glycol, dipropylene glycol, tripropylene glycol, 1,4-butanediol, cyclohexane dimethanol, ethylene diamine, phenylene diamine, bis(3-chloro-4-aminophenyl)methane, dimethylthio-toluenediamine and diethyltoluenediamine. According to a preferable embodiment of the present disclosure, the chain extender is a short chain polyol extender which only comprises hydroxyl group as the isocyanate-reactive group. More preferably, the chain extender is a polyol comprising from 2 to 12 carbon atoms and having a hydroxyl functionality of 2.0 to 8.0. According to a preferable embodiment of the present discloses, the chain extender is an aliphatic polyol or cyclo-aliphatic polyol. Preferable examples of the chain extender include ethylene glycol, propane diol, butane diol, pentane diol, hexane diol, and 1,4-cyclohexane dimethanol or their isomers. According to a preferable embodiment of the present disclosure, the amount of the chain extender is from 1 to 20% by weight, such as from 2 to 16% by weight, or from 4 to 12% by weight, or from 6 to 10% by weight, or from 7 to 8% by weight, based on the total weight of the component B.

The antioxidant is preferably included in component B but not in component A. According to a preferable embodiment of the present disclosure, the antioxidant is a substituted phenol type antioxidant, and is more preferably of sterically hindered phenol type. According to a preferable embodiment of the present disclosure, the amount of the antioxidant is from 0.3 to 2% by weight, such as from 0.5 to 1% by weight, based on the total weight of the component B.

The UV absorber is preferably included in component B but not in component A. According to a preferable embodiment of the present disclosure, the absorber is a benzotriaole type UV absorber, and is more preferably 2-(2H-benzotriazo-2-yl)-6-dodecyl-4-methyl-phenol. According to a preferable embodiment of the present disclosure, the amount of the UV absorber is from 0.5 to 2.5% by weight, such as from 1.0 to 1.8% by weight, based on the total weight of the component B.

The light stabilizer is preferably included in component B but not in component A. According to a preferable embodiment of the present disclosure, the light stabilizer is a hindered aliphatic light stabilizer (HALS), preferably a substituted alicyclic-amine HALS, and more preferably and bis(1,2,2,6,6-pentamethyl-4-piperidyl) sebacate. According to a preferable embodiment of the present disclosure, the amount of the UV absorber is from 0.5 to 2.5% by weight, such as from 1.0 to 1.8% by weight, based on the total weight of the component B.

The colorant, pigment and dye can be included in either component A or component B, and are preferably included in component B but not in component A. According to a preferable embodiment of the present disclosure, the colorant, pigment and dye include carbon black, titanium dioxide and isoindolinon. According to a preferable embodiment of the present disclosure, the amount of the UV absorber is from 0.3 to 3.0% by weight, based on the total weight of the component B.

The invention is applicable to prepare a material for a wide range of gaskets that can be used in many applications. The gasket can be used, for example, for an automobile or truck, any other type of transportation vehicles including an aircraft, as well as various types of agriculture, industrial and construction equipment. According to various embodiments of the present disclosure, the polyurethane product has a density of at least 500 kg/m³, such as from 500 to 1200 kg/m³, from 600 to 1100 kg/m³, from 700 to 1000 kg/m³, or from 800 to 900 kg/m³.

According a preferable embodiment of the present disclosure, the polyurethane composition is substantially free of water or moisture intentionally added therein. For example, “free of water” or “water free” means that the mixture of all the raw materials used for preparing the polyurethane composition comprise less than 3% by weight, preferably less than 2% by weight, preferably less than 1% by weight, more preferably less than 0.5% by weight, more preferably less than 0.2% by weight, more preferably less than 0.1% by weight, more preferably less than 100 ppm by weight, more preferably less than 50 ppm by weight, more preferably less than 10 ppm by weight, more preferably less than 1 ppm by weight of water, based on the total weight of the mixture of raw materials.

According to a preferable embodiment of the present disclosure, the polyurethane material is prepared by reaction injection molding (RIM) under an index between 90 and 120, wherein index 100 means the molar ratio between isocyanate group and isocyanate-reactive groups is 1.00. In various embodiments, the polyurethane material is prepared by mixing component A and component B at room temperature or at an elevated temperature of 30 to 120° C., preferably from 40 to 90° C., more preferably from 50 to 70° C., for a duration of e.g., 0.1 seconds to 10 hours, preferably from 5 seconds to 3 hours, more preferable from 10 seconds to 60 minutes. Mixing may be performed in a spray apparatus, a mix head, or a vessel. Following mixing, the mixture may be injected inside a cavity, in the shape of a gasket or any other proper shapes. This cavity may be optionally kept at atmospheric pressure or partially evacuated to sub-atmospheric pressure. Alternatively, the mixture may be directly applied onto a glass panel of the motor.

Upon reacting, the mixture takes the shape of the mold or adheres to the substrate to produce polyurethane material which is then allowed to cure, either partially or fully. Suitable conditions for promoting the curing of the polyurethane polymer include a temperature of from about 20° C. to about 150° C. In some embodiments, the curing is performed at a temperature of from about 30° C. to about 120° C. In other embodiments, the curing is performed at a temperature of from about 35° C. to about 110° C. In various embodiments, the temperature for curing may be selected at least in part based on the time duration required for the polyurethane polymer to gel and/or cure at that temperature. Cure time will also depend on other factors, including, for example, the particular components (e.g., catalysts and quantities thereof), and the size and shape of the article being manufactured.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments, within the scope of the claims, will be apparent from consideration of the specification and/or practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto.

### EXAMPLES

Some embodiments of the invention will now be described in the following Examples. However, the scope of the present disclosure is not, of course, limited to the formulations set forth in these examples. Rather, the Examples are merely inventive of the disclosure.

The information of the raw materials used in the examples is listed in the following table 1:

TABLE 1
Raw materials used in the examples

| Components | Grades | Detailed Information | Suppliers |
|---|---|---|---|
| Polyether polyol | Voranol CP 6001 | 14% EO capped propoxylated glycerin triol with a M_{W} of 6000. | Dow |
| | | | Chemical |
| Polyether polyol | Voranol EP 1900 | 20% EO capped propoxylated propylene glycol diol with a M_{W} of | Dow |
| | | 4000. | Chemical |
| Isocyanate | Hyperlast LE 5021 | An isocyanate component derived from the reaction of MDI | Dow |
| component | | compounds and short chain polyols. | Chemical |
| Antioxidant | Irganox 1135 | β-(3,5-di-tert-butyl-4-Hydroxylphenyl propionate isooctanol ester, | BASF |
| | | 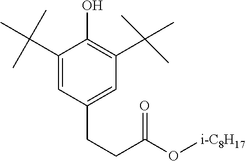 | |
| Peroxide | JPP-100 | Tetraphenyl dipropyleneglycol diphosphate, | Johoku |
| decomposer | | | Chemical |
| | | 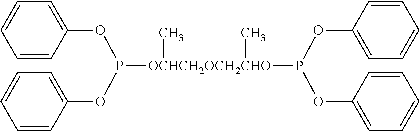 | |
| UV absorber | Tinuvin 571 | 2-(2H-benzotriazo-2-yl)-6-dodecyl-4-methyl-phennol, | BASF |
| | | 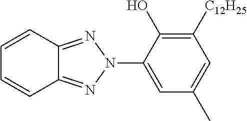 | |
| Light stabilizer | Tinuvin 765 | Bis(1,2,2,6,6-pentamethyl-4-piperidyl)sebacate, | BASF |
| | | 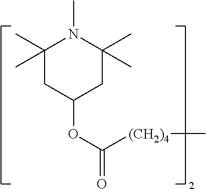 | |
| Anti-foamer | BYK 535 | Silicone-based anti-foamer | BYK |
| | | | Chemical |
| Pigment | Carbon black | Carbon black particles | Lanxess |
| Chain extender | Monoethylene Glycol (MEG) | 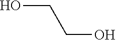 | Shanghai Tony Trade |
| Chain extender | Dimethyl thio-toluene diamine (DMTDA) | 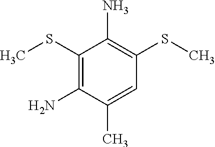 | Zhangjiagang Yarui |
| Comparative Cross linker | Triethanolamine (TEOA) | 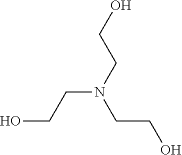 | Sinopharm Chemical |
| Inventive Cross linker | Triisopropanolamine (TiPOA) | 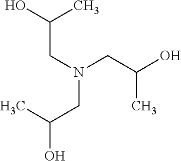 | Sinopharm Chemical |
| Organobismuth | Coscat 83 | Bismuth(III) neodecanoate, 16% Bismuth content | Vertellus |
| catalyst | | | |
| Organotin | Fomrez UL 28 | Organotin catalyst, | Momentive |
| catalyst | | | |
| Delayed amine | Dabco 8154 | formic acid blocked triethylene diamine in DPG, 33% | Evonik |
| catalyst | | | |

General Description of the Preparation of Polyurethane Materials

The inventive examples and comparative examples were conducted by using the formulations for the component A and component B as well as the reaction conditions summarized in the following Table 2, and the characterization results of these inventive examples and comparative examples are also summarized therein, wherein the carbon black was predispersed into CP 6001 to form a 25 wt. % polyol dispersion, and the polyisocyanate component (A) was premade by mixing Hyperlast™ LE 5021 with the peroxide decomposer JPP-100 (4.80 wt. %).

Component A and component B were mixed at room temperature using a speed-mixer at 3000 rpm for 6 seconds. Then the properties of the mixture were characterized before molding and curing.

Molded polyurethane elastomer products were prepared via mixing the polyol component and prepolymer component using a speed-mixer at 3000 rpm for 6 seconds and then pouring the mixtures into an open and vertical aluminum mold at room temperature. The molded materials were cured at room temperature for 24 hour and demolded to produce the PU molded products. Testing samples were then cut from the molded products and subject to characterization of weather-o-meter (WOM).

Characterization of Cream Time and Solidification Time

Cream time and solidification time were recorded for evaluation of the operation time and demold time of each sample, wherein the cream time was characterized on samples having no carbon black. The requirements of relevant field can be met by a sample having a cream time of higher than 15 seconds and a solidification time of smaller than 40 seconds.

Characterization of Storage Stability

Storage stability was evaluated by comparison of the cream time and solidification time of the mixtures with and without a storage of the polyol components at 50° C. for 7 days. It is required that the mixture prepared by using a polyol component at 50° C. for one week will exhibit cream time and solidification time comparable with those of the mixture prepared by using a “fresh” polyol component.

Characterization of Total VOC

Total VOC was measured according to the following procedures: the samples were cured for 72 h at 23° C./50% Relative humidity. Then the samples were wrapped in two layers of aluminum foils, packed in a sealable polyethylene bag and then stored under −18° C. until testing. About 70 g samples were cut and put into a 10 L gas bag. 7 L of nitrogen was filled into the gas bag. The gas bag were then stored at 65° C. for 2 h before analysis. 4 L of the gas was then purged through the DNPH-Silica cartridge. Then the cartridge was washed with 3.5 mL acetonitrile and eluted with 1 mL acetonitrile. Sample of the acetonitrile solution was then injected into a HPLC for carbonyl analysis. The requirements of relevant field can be met by a sample having a TVOC of less than 100 ppm.

Characterization of Weathering Properties

Weathering properties of the polyurethane elastomer product (WOM testing) were evaluated according to PSA D27-1389, which was briefly introduced as follows:

(a) the test specimens were exposed to a continuous light which was emitted by a Xenon lamp and has been filtrated through an adapted optical-filter;

(b) the light has an Irradiance of 0.55 W/m² at 340 nm;

(c) the thermometer temperature was set at 70±2° C.;

(d) the dry bulb temperature was set at 50±2° C.;

(Note: the thermometer and dry bulb temperatures were adjusted continuously in an automatic mode)

(e) the test specimens were subject to one sprinkling cycle comprising a sprinkling-stage of 18 minutes on the exposed side thereof followed by a non-sprinkling stage of 102 minutes;

(f) the relative humidity was kept at 50%±5% in the duration without sprinkling, wherein the temperature difference (ΔT) between the dry bulb temperature (T ° C._{dry-bulb}) and the temperature when the above stated relative humidity was applied (T ° C._{humid}) is 10.5° C. (ΔT=T ° C._{dry-bulb}−T ° C._{humid}).

Color change (ΔE) after 1000 h irradiance was characterized for evaluating the weather resistance of the polyurethane product.

TABLE 2
compositions, processing conditions and characterization results of
inventive examples (Inv.) 1-5 and comparative examples (Comp.) 1-3:

| | Example No. | Comp. 1 | Comp. 2 | Inv. 1 | Comp. 3 | Inv. 2 | Inv. 3 | Inv. 4 | Inv. 5 |
|---|---|---|---|---|---|---|---|---|---|
| | Entries ^{a} | E-01* | E-02* | E-03 | E-04* | E-05 | E-06 | E-07 | E-08 |
| Component | CP 6001 | 58.06 | 58.20 | 58.20 | 58.20 | 58.20 | 57.08 | 57.09 | 56.11 |
| B (wt %) | EP 1900 | 27.04 | 27.04 | 27.04 | 27.04 | 27.04 | 27.36 | 26.75 | 26.87 |
| | MEG | 9.00 | 9.00 | 9.00 | 9.00 | 9.00 | 7.80 | 7.40 | 6.76 |
| | DMTDA | 1.50 | | | | | | | |
| | TEOA | | 1.50 | | | | | | |
| | TiPOA | | | 1.50 | 1.50 | 1.50 | 3.50 | 4.50 | 6.00 |
| | Dabco 8154 | 0.10 | | | | | | | |
| | Fomrez UL 28 | 0.20 | | | | | | | |
| | Coscat 83 | | 0.16 | 0.16 | 0.16 | 0.16 | 0.16 | 0.16 | 0.16 |
| | BYK 535 | 0.10 | 0.10 | 0.10 | 0.10 | 0.10 | 0.10 | 0.10 | 0.10 |
| | Irganox 1135 | 0.60 | 0.60 | 0.60 | 0.60 | 0.60 | 0.60 | 0.60 | 0.60 |
| | Tinuvin 571 | 1.20 | 1.20 | 1.20 | 1.20 | 1.20 | 1.20 | 1.20 | 1.20 |
| | Tinuvin 765 | 1.20 | 1.20 | 1.20 | 1.20 | 1.20 | 1.20 | 1.20 | 1.20 |
| | Carbon black | 1.00 | 1.00 | 1.00 | 1.00 | 1.00 | 1.00 | 1.00 | 1.00 |
| | JPP-100 | | | | 3.00 | | | | |
| Component | LE 5021 | 58.14 | 60.49 | 59.38 | 59.38 | 59.38 | 58.09 | 58.51 | 58.92 |
| A (wt %) | JPP-100 | 4.80 | 4.80 | | | 4.80 | 4.80 | 4.80 | 4.80 |
| Condition | Mol_{NCO}/Mol_{OH} | 1.04 | 1.04 | 1.04 | 1.04 | 1.04 | 1.04 | 1.04 | 1.04 |
| | Temperature (° C.) | 23.00 | 23.00 | 23.00 | 23.00 | 23.00 | 23.00 | 23.00 | 23.00 |
| Property | Cream (s) | 5 | 12 | 19 | 34 | 19 | 20 | 21 | 22 |
| | Solidification (s) | 7 | 25 | 27 | 50 | 27 | 26 | 27 | 27 |
| | Cream (s) after | 6 | 13 | 19 | 52 | 19 | 22 | 23 | 21 |
| | storage | | | | | | | | |
| | Solidification (s) | 9 | 26 | 26 | 200 | 26 | 29 | 32 | 26 |
| | after storage | 305 | 55 | 51 | 65 | 73 | 38 | 45 | 79 |
| | TVOC (ppm) | | | | | | | | |
| | Color change | N/A ^{c} | N/A ^{d} | 1.00 | N/A ^{e} | 0.79 | 0.53 | 0.66 | 0.44 |
| | (ΔE)^{b} | | | | | | | | |

Notes:
^{a} Stars (*) indicate comparative examples.
^{b}Color change (ΔE) refers to the color change after 1000 h irradiance and the values were normalized based on that of Inventive Example 1 (i.e. E-03).
^{c} Color change was not determined due to high volatility of the system.
^{d} Color change was not determined due to poor processability.
^{e} Color change was not determined due to poor storage stability.
^{f} The amounts of each ingredients for component A were expressed in weight percentage by taking the total amount of the component B as 100 wt %.

As can be seen from the above table 2, Comparative Example 1, which comprise catalysts different from that used in the inventive examples, exhibit a much higher total VOC value. Comparative Example 2, whose crosslinker is an organic amine comprising primary hydroxyl group rather than secondary hydroxyl, exhibits much shorter cream time when compared with those of the inventive examples that illustrate superior flowability and longer operation time. Furthermore, Example 2, which does not comprise the peroxide decomposer JPP-100 in component A, has a weathering resistance notably lower than that of Example 5, which comprises the peroxide decomposer JPP-100 in component A.

The comparison between Comparative Example 3 and the inventive examples shows that the inclusion of said peroxide decomposer JPP-100 in component B (instead of in component A) will bring about poor storage stability (represented by cream time and solidification time).

### Examples 6 to 8

Three additional inventive examples were conducted by repeating the exact procedures of inventive example 1, except that TiPOA was replaced with equivalent amount of diisopropanolamine (example 6), N,N,N′,N″,N″-pentakis(2-hydroxypropyl)diethylenetriamine (example 7) and tri(tert-butanol)amine (example 8). It turns out that all of these three examples 6-8 exhibit storage stability (represented by cream time and solidification time) and weathering resistance comparable to those of inventive example 1.

1. A polyurethane composition, comprising
one polyisocyanate component comprising at least one aromatic polyisocyanate compound and/or isocyanate end-capped prepolymer derived from the reaction of said at least one aromatic polyisocyanate compound and at least one first polyol;
at least one second polyol; and
a crosslinker having at least one nitrogen atom and at least one secondary and/or tertiary hydroxyl group.

2. The polyurethane composition according to claim 1, wherein the polyurethane composition is a two-component composition comprising:
(A) a component A comprising the aromatic polyisocyanate compound and/or the isocyanate end-capped prepolymer; and
(B) a component B comprising at least one second polyol and the crosslinker.

3. The polyurethane composition according to claim 1, wherein the crosslinker is represented by Formula (I): 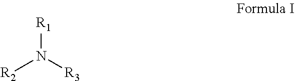
wherein each of R1, R2 and R3 is independently selected from the group consisting of hydrogen, C1 to C10 alkyl, C3 to C10 cycloalkyl, methyl(hydroxyl)C1 to C9 alkylene, ethyl(hydroxyl)C1 to C8 alkylene, propyl(hydroxyl) C1 to C7 alkylene, butyl(hydroxyl) C1 to C6 alkylene, dimethyl(hydroxyl)C1 to C8 alkylene, diethyl(hydroxyl)C1 to C6 alkylene, dipropyl(hydroxyl) C1 to C4 alkylene, di(C1 to C10 alkyl group)amino, di(C1 to C10 alkyl group)amino-C1 to C10 alkylene, di[methyl(hydroxyl)C1 to C8 alkylene]amino and di[methyl(hydroxyl)C1 to C8 alkylene]amino-C1 to C10 alkylene, with the proviso that the crosslinker comprise at least one secondary and/or tertiary hydroxyl group.

4. The polyurethane composition according to claim 3, wherein the crosslinker comprises from three to six secondary hydroxyl groups and/or tertiary hydroxyl groups.

5. The polyurethane composition according to claim 1, wherein the crosslinker is selected from the group consisting of tri(2-hydroxyl-ethyl)amine, triisopropanolamine, triisobutanolamine, triisopentanolamine, tetra(2-hydroxyl-ethyl)diamine, tetra(isobutanol)diamine, tetra(isopentanol)diamine, tri(tert-butanol)amine, tri(tert-pentanol)amine, tri(tert-hexanol)amine, N,N,N″,N″-tetra(2-hydroxypropyl) diethylenetriamine, N,N,N′,N″,N″-pentakis(2-hydroxypropyl) diethylenetriamine and any combinations thereof.

6. The polyurethane composition according to claim 2, wherein the amount of the crosslinker is from 0.1 to 10% by weight, based on the total weight of the component B.

7. The polyurethane composition according to claim 2, wherein the component A further comprises a peroxide decomposer.

8. The polyurethane composition according to claim 7, wherein the peroxide decomposer is selected from the group consisting of aliphatic organophosphite, aromatic organophosphite, aliphatic sulfur ether, aromatic sulfur ether, and any combinations thereof; and
the amount of the peroxide decomposer is from 0.1 to 17.5% by weight, based on the total weight of the component A.

9. The polyurethane composition according to claim 1, wherein the aromatic polyisocyanate compound comprises at least one aromatic ring and all the isocyanate groups are directly attached to the aromatic ring without the existence of any interlink group therebetween.

10. The polyurethane composition according to claim 2, wherein the component B further comprises at least one additive selected from the group consisting of chain extender, catalyst, antioxidant, UV absorber, light stabilizer, colorant, dye, pigment, anti-statistic reagent, plasticizer, flame-retardant agent, and any combinations thereof.

11. The polyurethane composition according to claim 1, wherein the aromatic polyisocyanate compound is selected from the group consisting of C6-C15 aromatic polyisocyanate comprising at least two isocyanate groups, C7-C15 araliphatic polyisocyanate comprising at least two isocyanate groups, carbodiimide modified derivatives thereof, and any combinations thereof; and
each of the first polyol and the second polyol is independently selected from the group consisting of C2-C16 aliphatic polyhydric alcohols comprising at least two hydroxy groups, dimer of the C2-C16 aliphatic polyhydric alcohols comprising at least two hydroxy groups, trimer of the C2-C16 aliphatic polyhydric alcohols comprising at least two hydroxy groups, C6-C15 cycloaliphatic or aromatic polyhydric alcohols comprising at least two hydroxy groups, C7-C15 araliphatic polyhydric alcohols comprising at least two hydroxy groups, polyester polyols having a molecular weight from 500 to 5,000, polycarbonate polyols having a molecular weight from 200 to 5,000, polyether polyols having an average functionality of 2 to 5 and an average molecular weight of 200 to 12,000, C2 to C10 polyamine comprising at least two amino groups, C2 to C10 polythiol comprising at least two thiol groups, C2-C10 alkanolamine comprising at least one hydroxyl group and at least one amino group, vegetable oil having at least two hydroxyl groups, and a combination thereof.

12. A polyurethane product prepared by using the polyurethane composition according to claim 1.

13. A method for preparing the polyurethane product according to claim 12, comprising the steps of:
i) providing the polyisocyanate component; and
ii) reacting the polyisocyanate component with the second polyol and the crosslinker to form the polyurethane product.

14. A method for improving the performance property of a polyurethane product, comprising the step of covalently linking at least one repeating unit derived from a crosslinker having at least one nitrogen atom and at least one secondary and/or tertiary hydroxyl group in a polyurethane chain of the polyurethane product, wherein the performance property includes at least one of operation time, aging resistance, weathering resistance, color stability, processability, and storage stability.
